(19) United States
(12) Patent Application Publication
(10) Pub. No.: US 2009/0132279 A1
(43) Pub. Date: May 21, 2009

(54) METHOD AND APPARATUS FOR SIGNIFICANT AND KEY IMAGE NAVIGATION

(75) Inventor: Vijaykalyan Yeluri, Sunnyvale, CA (US)

Correspondence Address: MCANDREWS HELD & MALLOY, LTD, 500 WEST MADISON STREET, SUITE 3400, CHICAGO, IL, 60661, US

(73) Assignee: GENERAL ELECTRIC COMPANY, Schenectady, NY (US)

(21) Appl. No.: 11/943,804

(22) Filed: Nov. 21, 2007

(51) Int. Cl. G06F 19/00

(52) U.S. Cl. 705/3

(57) ABSTRACT

Certain embodiments of the present invention provide methods and systems for navigation and review of significant and/or key images in an image series. Certain embodiments provide a method for image navigation and review. The method includes facilitating graphical user navigation through images in an image series for a patient, the image series including a plurality of significant and/or key images. The method also includes enabling navigation from a first significant or key image to a second significant or key image in the image series based on stored navigation information identifying significant and/or key images in the image series. The method further includes allowing navigation to view one or more images adjacent to a significant or key image in the image series.

### BACKGROUND OF THE INVENTION

Healthcare environments, such as hospitals or clinics, include information systems, such as hospital information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include patient medical histories, imaging data, test results, diagnosis information, management information, and/or scheduling information, for example. The information may be centrally stored or divided at a plurality of locations. Healthcare practitioners may desire to access patient information or other information at various points in a healthcare workflow. For example, during surgery, medical personnel may access patient information, such as images of a patient's anatomy, that are stored in a medical information system. Radiologist and/or other clinicians may review stored images and/or other information, for example.

A reading, such as a radiology or cardiology procedure reading, is a process of a healthcare practitioner, such as a radiologist or a cardiologist, viewing digital images of a patient. The practitioner performs a diagnosis based on a content of the diagnostic images and reports on results electronically (e.g., using dictation or otherwise) or on paper. The practitioner, such as a radiologist or cardiologist, typically uses other tools to perform diagnosis. Some examples of other tools are prior and related prior (historical) exams and their results, laboratory exams (such as blood work), allergies, pathology results, medication, alerts, document images, and other tools. For example, a radiologist or cardiologist typically looks into other systems such as laboratory information, electronic medical records, and healthcare information when reading examination results.

A practitioner, such as a radiologist or cardiologist, may focus primarily on certain images (“significant images”) to perform an analysis. Identification of significant or key images reduces a number of images a referral physician or other practitioner examines for diagnosis and/or treatment of a patient. Currently, significant images are manually identified by the practitioner from the images viewed in an exam. Radiologists manually create a significant or key image series by selecting images and changing image status to “Significant” or “Key”.

Currently, a significant images series saves only the images that are marked as significant. Radiologists and/or other viewer must switch between series manually. Additionally, current PACS users must scroll through an exam to look for the significant images.

### BRIEF SUMMARY OF THE INVENTION

Certain embodiments of the present invention provide methods and systems for navigation and review of significant and/or key images in an image series.

Certain embodiments provide a method for image navigation and review. The method includes facilitating graphical user navigation through images in an image series for a patient, the image series including a plurality of significant and/or key images. The method also includes enabling navigation from a first significant or key image to a second significant or key image in the image series based on stored navigation information identifying significant and/or key images in the image series. The method further includes allowing navigation to view one or more images adjacent to a significant or key image in the image series.

In certain embodiments, the method additional includes linking images in the image series with historical images in a prior image series and providing linked historical images for viewing in conjunction with images being viewed from the image series, for example.

Certain embodiments provide a radiology reading workstation for display and review of patient images. The workstation includes a memory storing an image series including a plurality of significant and/or key images and a plurality of other images. The workstation also includes a processor facilitating navigation of and operations on images in the image series. The workstation further includes a user interface, in conjunction with the processor, facilitating display of images in the image series and accepting user input for navigation and annotation within the image series. The user interface enables navigation from a first significant or key image to a second significant or key image in the image series based on stored navigation information identifying significant and/or key images in the image series. The user interface further allows navigation to view one or more images adjacent to a significant or key image in the image series.

In certain embodiments, the processor links images in the image series with historical images in a prior image series and provides linked historical images for viewing in conjunction with images being viewed from the image series via the user interface.

Certain embodiments provide a computer-readable medium having a set of instructions for execution on a computer. The set of instructions includes a data structure storing an image series including a plurality of significant and/or key images and a plurality of other images. The set of instructions also includes a processing routine facilitating navigation of and operations on images in the image series. The set of instructions further includes a user interface routine facilitating display of images in the image series and accepting user input for navigation and annotation within the image series. The user interface routine enables navigation from a first significant or key image to a second significant or key image in the image series based on stored navigation information identifying significant and/or key images in the image series. The user interface routine further allows navigation to view one or more images adjacent to a significant or key image in the image series.

### BRIEF DESCRIPTION OF SEVERAL VIEWS OF THE DRAWINGS

FIG. 1 depicts a series of images including a plurality of significant images as well as a plurality of non-significant images in accordance with an embodiment of the present invention.

FIG. 2 illustrates a system for clinical data storage and retrieval in accordance with an embodiment of the present invention.

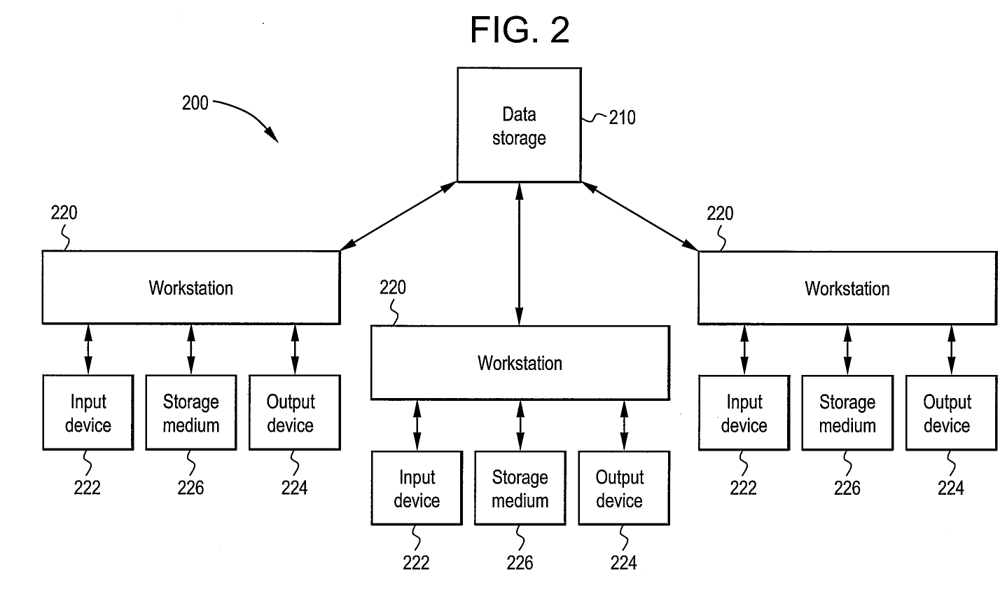

FIG. 3 shows a flow diagram for a method for significant or key image navigation in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Image review and analysis often account for a significant component of a healthcare workflow. For example, in a radiology reading, a radiologist spends a significant portion of his or her time reading and analyzing clinically relevant images. Clinically relevant images are the images that may be used for diagnosing a patient's medical condition, for example.

In order to read images, a radiologist may use a variety of tools, such as window level, zoom/pan, rotate, image filter(s), process, cine, annotate, etc., to apply different settings to significant or key images as opposed to other obtained images. For example, a user may dynamically modify a display window level to read images. Different window level settings may allow a user to better view an image or anatomy within an image, for example. A user may zoom and/or pan images for details, for example. A user may rotate and/or flip an image, for example. A user may apply one or more filters to an image to read specific areas of a body part or anatomy of interest. A user may apply image processing tools to image data, for example. Using cine, a user may navigate images quickly, for example. Additionally, a user may annotate image(s) to indicate findings, priority, and/or other note(s), for example. These and other tools may be applied to one or more images for reading.

However, radiologists may wish to see images adjacent to a significant image in order to see the progression of a lesion or anomaly, for example. Additionally, in a link mode, a radiologist can quickly compare a significant image in a current exam with an image at the same location in a historical exam quickly and efficiently. Today, radiologists must switch between the series manually. In other systems, historical significant image comparison does not exist in an automated fashion.

A typical read-out of an exam by a radiologist includes opening a new exam as well as relevant exams acquired in the past. The radiologist examines one or more reports from the prior exams to determine if any changes have occurred from the prior exams to the current exam in addition to the current reason the patient has been scanned. The radiologist opens each series in the current exam and navigates through the images looking for any abnormalities. Upon finding an abnormality, the radiologist annotates the abnormality. The radiologist may mark the image as either significant, using a significant image marker tool, or a key image, allowing the radiologist to type notes on the finding. In certain embodiments, a new series of images may be created that includes images that have been either marked as significant or key images.

After examining the study, the radiologist opens the significant/key image series and, following his or her annotations and notes on abnormalities, dictates and/or otherwise generates a report. The radiologist does not have access to the images adjacent to the significant images in this context.

Certain embodiments of the present invention provide a keyboard and/or other navigational shortcut to allow a user to quickly and efficiently navigate to significant/key image(s) in an exam. When looking at a significant/key image, the user can scroll back and forth to review adjacent images in the series. Certain embodiments provide a “Link” mode. In link mode, when a user navigates or “jumps to” a significant or key image in the current exam, an image at the same location in a historical exam is also automatically displayed. This allows the user to compare the changes between exams quickly and efficiently.

In certain embodiments, a user can view his or her significant/key image(s) without having to change a series selection from an exam series to the “Significant image” or “Key image” series. The user can browse an “All images” series, for example, and use a keyboard shortcut to jump through significant images in one or more series to dictate his or her report, without loosing access to contextual information for the images (e.g., adjacent images to the significant or key images).

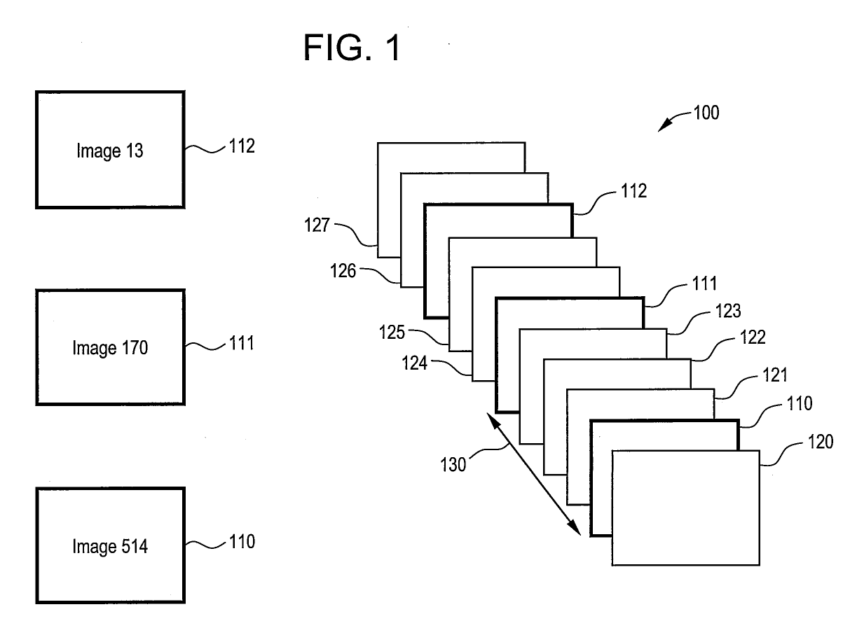

FIG. 1 depicts a series 100 of images including a plurality of significant images 110-112 as well as a plurality of non-significant images 120-127 in accordance with an embodiment of the present invention. As shown in FIG. 1, a significant image 110 is surrounded by other images 120 and 121 that are not marked as significant or key images. A keyboard and/or other interface shortcut, indicated in FIG. 1 by arrow 130, allows a user to jump to the first significant image 110 in the exam series 100. The user can then navigate to view adjacent images 120 and 121. For example, the user may wish to look at the adjacent images 120, 121 to show progression of a tumor. When the user wishes to view the next significant image, the shortcut 130 navigates the user to the next significant image 111.

In an embodiment, a significant/key image information, alone and/or in conjunction with reading order information, may be stored in a data table, image file header, data structure, etc. In an embodiment, an image table may be modified to include an entry for image significance. In an embodiment, a flag or other data field associated with each image may be included in a header or data table/structure for reading order and/or significance of the image.

In an embodiment, significant and/or key images in an image study may be matched to significant and/or key images in a previous image study. For example, images in a new study may be registered with images in a previous study, and significant/key images in the new study may be linked for display according to corresponding significant/key images in the previous study. Image linking information may be stored in a data table, file header, data structure, etc.

Thus, certain embodiments provide access to and display of clinically relevant images of a historical study. Certain embodiments provide access to and display of clinically relevant images of a current study while image reading is in progress. Certain embodiments allow ordering and/or prioritization of images while still allowing easy viewing of images adjacent to key/significant images.

Certain embodiments associate a level of significance with one or more images in one or more studies. In certain embodiments, the level of significance of an image may be based on one or more parameters. Parameters may include clinical relevance, diagnosis patterns in the image, an amount of time spent reading the image, for example.

In an embodiment, when a user, such as a radiologist or other healthcare practitioner, is reading a new study, the user may see the most significant images in a prior study to drive comparison studies. In an embodiment, significance levels stored with respect to a prior study may be used to prioritize images in a subsequent study. For example, images in a new study may be registered with respect to prior images to determine a correlation between images. New images may be assigned a level of significance equal or similar to a corresponding prior image, for example. In an embodiment, images may be compared to reference images using pattern matching or registration techniques, for example, to determine a level of significance for each image.

Significant and/or key images may be reviewed on a clinical workstation in a clinical information system, such as a PACS system, for example. In certain embodiments, an interface including patient information and tasks may be viewed and/or constructed using a system such as system 200 including at least one data storage 210 and at least one workstation 220. While three workstations 220 are illustrated in system 200, a larger or smaller number of workstations 220 can be used in accordance with embodiments of the presently described technology. In addition, while one data storage 210 is illustrated in system 200, system 200 can include more than one data storage 210. For example, each of a plurality of entities (such as remote data storage facilities, hospitals or clinics) can each include one or more data stores 210 in communication with one or more workstations 220.

As illustrated in system 200, one or more workstations 220 can be in communication with at least one other workstation 220 and/or at least one data storage 210. Workstations 220 can be located in a single physical location or in a plurality of locations. Workstations 220 can be connected to and communicate via one or more networks.

Workstations 220 can be directly attached to one or more data stores 210 and/or communicate with data storage 210 via one or more networks. Each workstation 220 can be implemented using a specialized or general-purpose computer executing a computer program for carrying out the processes described herein. Workstations 220 can be personal computers or host attached terminals, for example. If workstations 220 are personal computers, the processing described herein can be shared by one or more data stores 210 and a workstation 220 by providing an applet to workstation 220, for example.

Workstations 220 include an input device 222, an output device 224 and a storage medium 226. For example, workstations 220 can include a mouse, stylus, microphone and/or keyboard as an input device. Workstations 220 can include a computer monitor, liquid crystal display (“LCD”) screen, printer and/or speaker as an output device.

Storage medium 226 of workstations 220 is a computer-readable memory. For example, storage medium 226 can include a computer hard drive, a compact disc (“CD”) drive, a USB thumb drive, or any other type of memory capable of storing one or more computer software applications. Storage medium 226 can be included in workstations 220 or physically remote from workstations 220. For example, storage medium 226 can be accessible by workstations 220 through a wired or wireless network connection.

Storage medium 226 includes a set of instructions for a computer. The set of instructions includes one or more routines capable of being run or performed by workstations 220. The set of instructions can be embodied in one or more software applications or in computer code.

Data storage 210 can be implemented using a variety of devices for storing electronic information such as a file transfer protocol (“FTP”) server, for example. Data storage 210 includes electronic data. For example, data storage 210 can store image data, non-image data, and/or other electronic medical record information for a plurality of patients. Data storage 210 may include and/or be in communication with one or more clinical information systems, for example.

Communication between workstations 220, workstations 220 and data storage 210, and/or a plurality of data stores 210 can be via any one or more types of known networks including a local area network (“LAN”), a wide area network (“WAN”), an intranet, or a global network (for example, Internet). Any two of workstations 220 and data stores 210 can be coupled to one another through multiple networks (for example, intranet and Internet) so that not all components of system 200 are required to be coupled to one another through the same network.

Any workstations 220 and/or data stores 210 can be connected to a network or one another in a wired or wireless fashion. In an example embodiment, workstations 220 and data store 210 communicate via the Internet and each workstation 220 executes a user interface application to directly connect to data store 210. In another embodiment, workstation 220 can execute a web browser to contact data store 210. Alternatively, workstation 220 can be implemented using a device programmed primarily for accessing data store 210.

Data storage 210 can be implemented using a server operating in response to a computer program stored in a storage medium accessible by the server. Data storage 210 can operate as a network server (often referred to as a web server) to communicate with workstations 220. Data storage 210 can handle sending and receiving information to and from workstations 220 and can perform associated tasks. Data storage 210 can also include a firewall to prevent unauthorized access and enforce any limitations on authorized access. For instance, an administrator can have access to the entire system and have authority to modify portions of system 200 and a staff member can only have access to view a subset of the data stored at data store 210. In an example embodiment, the administrator has the ability to add new users, delete users and edit user privileges. The firewall can be implemented using conventional hardware and/or software.

Data store 210 can also operate as an application server. Data store 210 can execute one or more application programs to provide access to the data repository located on data store 210. Processing can be shared by data store 210 and workstations 220 by providing an application (for example, a java applet). Alternatively, data store 210 can include a stand-alone software application for performing a portion of the processing described herein. It is to be understood that separate servers may be used to implement the network server functions and the application server functions. Alternatively, the network server, firewall and the application server can be implemented by a single server executing computer programs to perform the requisite functions.

The storage device located at data storage 210 can be implemented using a variety of devices for storing electronic information such as an FTP server. It is understood that the storage device can be implemented using memory contained in data store 210 or it may be a separate physical device. The storage device can include a variety of information including a data warehouse containing data such as patient image and other medical data, for example.

Data storage 210 can also operate as a database server and coordinate access to application data including data stored on the storage device. Data storage 210 can be physically stored as a single database with access restricted based on user characteristics or it can be physically stored in a variety of databases.

In an embodiment, data storage 210 is configured to store data that is recorded with or associated with a time and/or date stamp. For example, a data entry can be stored in data storage 210 along with a time and/or date at which the data was entered or recorded initially or at data storage 210. The time/date information can be recorded along with the data as, for example, metadata. Alternatively, the time/date information can be recorded in the data in manner similar to the remainder of the data. In another alternative, the time/date information can be stored in a relational database or table and associated with the data via the database or table.

In an embodiment, data storage 210 is configured to store medical data for a patient in an EMR. The medical data can include data such as numbers and text. The medical data can also include information describing medical events. For example, the medical data/events can include a name of a medical test performed on a patient. The medical data/events can also include the result(s) of a medical test performed on a patient. For example, the actual numerical result of a medical test can be stored as a result of a medical test. In another example, the result of a medical test can include a finding or analysis by a caregiver that entered as text.

In certain embodiments, hanging and display protocols are used to display images and configure a user interface and display area on a display 224. Rules and other protocols may also govern display, control, and manipulation of content at a workstation 220.

In an embodiment, a user, such as a radiologist, may review images via an output display device 224. The user may identify one or more of the images as significant images. In an embodiment, access to significant images may be streamlined or shortcut. For example, a user may access one or more significant images with a single click of a mouse button or other simple selection to reduce a user's effort in locating significant images when reviewing an exam or collection of images. A medical information system, such as a PACS system, may store significant image information to enable simplified retrieval of significant images by a user.

In an embodiment, one or more significant and/or most read images for a user may be selected automatically based on the length of time an image has been viewed by the user. For example, the images viewed for longer than a certain time period are automatically selected as significant and/or most read images. The time period may be selected by a user, administrator, system parameter, and/or experimental data, for example. Alternatively, a system may be configured to store a certain number (n) of significant and/or most read images for a user. The n images viewed for the longest period of time by the user are then denoted as significant and/or most read images, for example. Inage status and/or viewing times may be stored as meta-data, for example, associated with each image. In another embodiment, most recently viewed images may be stored for a user. For example, the n most recently viewed images and/or images viewed within a certain time period may be stored for a user or group of users.

The significant and/or most read images may be flagged using meta-data stored in or with the images or denoted in a table or database, for example. In an embodiment, a user may be alerted to the detection and storage of significant and/or most read images. The user may review the selected significant and/or most read images and modify significant and/or most read image designation if desired. Significant and/or most read image identification may occur automatically and/or may be triggered by a user via software or other electronic trigger, for example. In an embodiment, gaze-based significant and/or most read image selection may be augmented by and/or work in conjunction with voice command and mousing device input, for example. In an embodiment, significant and/or most read images and/or a report, such as a radiology report, may be transmitted automatically or by a user to another practitioner, such as a specialist or referral physician, for review.

A visual tracking system, such as a gaze detection and/or other head/eye tracking system, may be used to track user dwell or gaze time for images being displayed. The visual tracking system may be a separate system or may be integrated with a PACS or other medical system, for example. In an embodiment, user dwell time is measured when the user is looking at an image. The visual tracking system does not track dwell time when the user is looking at text, buttons, or other peripheral content, for example. The tracking system tracks a user's gaze in relation to the display device. The user's gaze location on the display device may be mapped to content displayed at display device. The system may determine at which content the user is looking. The visual tracking system or other processor or software may compare image dwell times to determine significant and/or most read images based on criteria, such as a minimum time threshold, a minimum and/or maximum number of images, etc.

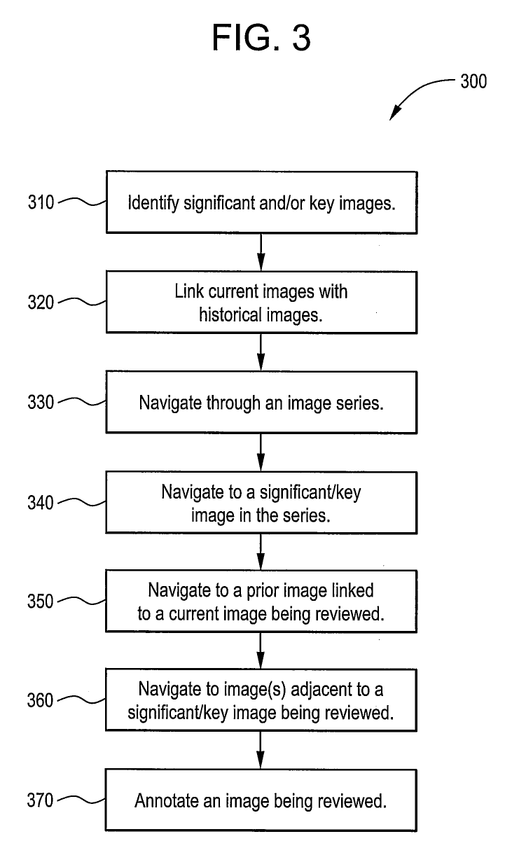

FIG. 3 shows a flow diagram for a method 300 for significant or key image navigation in accordance with an embodiment of the present invention. First, at step 310, significant/key image(s) are identified. For example, a radiologist reviews a series of images in a study from a patient examination and marks certain images as significant or key images. Information is stored in image file headers, an image data table, etc. As another example, user dwell or viewing time periods are compared to determine the most viewed and/or longest viewed images. The images with the largest dwell times may be designated as significant or most read images, for example. Meta-data or other data associated with the significant or most read images may be modified to designate the images as significant or most read images, for example.

At step 320, current images are linked with historical images. For example, image registration is performed between significant/key images in the current image study for a patient and significant/key images in a prior image study for that patient. Feature matching, image file meta-data, and/or exam information may be used to correlate present and past images, for example.

At step 330, a user navigates through the image series. The image series includes significant and/or key images and images not labeled as significant/key images. Keystrokes, mouse movement, touchscreen selection, voice command, eye tracking command, automated sequencing, etc., may be used to navigate between images in the series.

At step 340, a user navigates to a significant/key image in the series. For example, information such as a table, image file header, image file meta-data, etc., may be used to identify significant image(s) and allow the user to navigate to a significant image for viewing. A shortcut based on such information allows a user to advance between significant images in the series while skipping over other intervening images. In certain embodiments, a shortcut may also allow a user to jump between image series to view significant or key images.

At step 350, a user may navigate to a prior image linked to the current image being reviewed. For example, information such as a table, image file header, image file meta-data, etc., may be used to identify historical image(s) related to a current image being reviewed. A link based on such information allows a user to view historical image(s) in addition to and/or in conjunction with the current image.

At step 360, a user may navigate to image(s) adjacent to a significant/key image being reviewed. For example, sequential image navigation is available in conjunction with shortcut and/or linked navigation between significant/key images. A user may navigate to a key image and then review image(s) adjacent to the key image to provide contextual information about an anatomy being imaged, such as progression of a tumor in the anatomy.

At step 370, a user may annotate an image being reviewed. For example, a user may add notes or comments to an image file and/or a document saved in conjunction with the image file. As another example, a user may use annotation tools to edit and/or otherwise add textual and/or graphical marks to the image, such as circling a region of interest in the image.

One or more of the steps of the method 300 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

In certain embodiments, significant images may be ordered based on a level of significance. Ordering images based on level of significance allows quick access to the images with highest level of significance in a series. Certain embodiments help facilitate quick review of current and historical studies based on significant images. Certain embodiments may be incorporated into a PACS workstation and/or other processor for ordering images based on significance.

In certain embodiments, significant images generated for a study may have different significant levels. Certain embodiments allow a radiologist to create a significant image series with a level of significance, which may be used by referring physicians for quick review of the images. In certain embodiments, a level of significance may be generated automatically, when the user marks an image as significant. The level of significance of historical studies may be used when reviewing/reading a current study.

Thus, certain embodiments provide a technical effect of navigating significant/key images and other images in a single series. Certain embodiments provide a technical effect of linking significant and/or key images within a series to enable a user to skip between significant/key images in the series. Certain embodiments allow current images to be linked with historical images for viewing of both current and prior images in a study.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

For example, certain embodiments provide a computer-readable medium having a set of instructions for execution on a computer. The set of instructions includes a data structure storing an image series including a plurality of significant and/or key images and a plurality of other images. The set of instructions also includes a processing routine facilitating navigation of and operations on images in the image series. The set of instructions further includes a user interface routine facilitating display of images in the image series and accepting user input for navigation and annotation within the image series. The user interface routine enables navigation from a first significant or key image to a second significant or key image in the image series based on stored navigation information identifying significant and/or key images in the image series. The user interface routine further allows navigation to view one or more images adjacent to a significant or key image in the image series.

In certain embodiments, the processing routine links images in the image series with historical images in a prior image series and provides linked historical images for viewing in conjunction with images being viewed from the image series in conjunction with the user interface routine. In certain embodiments, the user interface routine includes a keyboard shortcut allowing a user to navigate between significant and/or key images in the image series.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated computer-readable media provide nonvolatile storage of computer-executable instructions, data structures, program modules and other data for the computer.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for image navigation and review, said method comprising:
facilitating graphical user navigation through images in an image series for a patient, the image series including a plurality of significant and/or key images;
enabling navigation from a first significant or key image to a second significant or key image in the image series based on stored navigation information identifying significant and/or key images in the image series; and
allowing navigation to view one or more images adjacent to a significant or key image in the image series.

2. The method of claim 1, further comprising linking images in the image series with historical images in a prior image series and providing linked historical images for viewing in conjunction with images being viewed from the image series.

3. The method of claim 1, further comprising saving annotation by a user to one or more images in the image series.

4. The method of claim 1, further comprising labeling an image in the image series as significant or key based on user input.

5. The method of claim 1, wherein meta-data associated with images in the image series denotes images as significant or key images.

6. The method of claim 2, wherein meta-data associated with images in the image series provided link information to the historical images in the prior image series.

7. The method of claim 1, further comprising displaying patient exam data to a user in conjunction with the images in the image series.

8. The method of claim 1, further comprising generating a report based on user input and image information from the image series.

9. A radiology reading workstation for display and review of patient images, said workstation comprising:
a memory storing an image series including a plurality of significant and/or key images and a plurality of other images;
a processor facilitating navigation of and operations on images in the image series; and
a user interface, in conjunction with the processor, facilitating display of images in the image series and accepting user input for navigation and annotation within the image series, the user interface enabling navigation from a first significant or key image to a second significant or key image in the image series based on stored navigation information identifying significant and/or key images in the image series, the user interface further allowing navigation to view one or more images adjacent to a significant or key image in the image series.

10. The workstation of claim 9, wherein the processor links images in the image series with historical images in a prior image series and provides linked historical images for viewing in conjunction with images being viewed from the image series via the user interface.

11. The workstation of claim 9, wherein the user interface, in conjunction with the processor, facilitates labeling of an image in the image series as significant or key based on user input.

12. The workstation of claim 9, wherein meta-data associated with images in the image series denotes images as significant or key images.

13. The workstation of claim 10, wherein meta-data associated with images in the image series provided link information to the historical images in the prior image series.

14. The workstation of claim 9, wherein the user interface displays patient exam data from the memory to a user in conjunction with the images in the image series.

15. The workstation of claim 9, wherein the user interface, in conjunction with the processor, generates a report based on user input and image information from the image series.

16. The workstation of claim 9, wherein a keyboard shortcut allows a user to navigate between significant and/or key images in the image series via the user interface.

17. The workstation of claim 9, wherein the workstation comprises a picture archiving and communication system workstation.

18. A computer-readable medium having a set of instructions for execution on a computer, the set of instructions comprising:
a data structure storing an image series including a plurality of significant and/or key images and a plurality of other images;
a processing routine facilitating navigation of and operations on images in the image series; and
a user interface routine facilitating display of images in the image series and accepting user input for navigation and annotation within the image series, the user interface routine enabling navigation from a first significant or key image to a second significant or key image in the image series based on stored navigation information identifying significant and/or key images in the image series, the user interface routine further allowing navigation to view one or more images adjacent to a significant or key image in the image series.

19. The computer-readable medium of claim 18, wherein the processing routine links images in the image series with historical images in a prior image series and provides linked historical images for viewing in conjunction with images being viewed from the image series in conjunction with the user interface routine.

20. The computer-readable medium of claim 18, wherein the user interface routine includes a keyboard shortcut allowing a user to navigate between significant and/or key images in the image series.
